(19) United States
(12) Patent Application Publication
(10) Pub. No.: US 2025/0343689 A1
(43) Pub. Date: Nov. 6, 2025

(54) CRYPTOGRAPHIC IDENTITY VERIFICATION SYSTEMS AND METHODS

(71) Applicant: Kristopher K. Durski, Moraga, CA (US)

(72) Inventor: Kristopher K. Durski, Moraga, CA (US)

(21) Appl. No.: 19/186,451

(22) Filed: Apr. 22, 2025

Related U.S. Application Data
(60) Provisional application No. 63/641,290, filed on May 1, 2024.

(51) Int. Cl. H04L 9/14

(52) U.S. Cl. CPC H04L 9/14

(57) ABSTRACT

Provided are techniques for cryptographically verifying identity that include: obtaining, by a first entity, a cryptographic private key associated with a user; obtaining, by a second entity, a cryptographic public key corresponding to the private key; generating, by the second entity, a nonce; encrypting, by the second entity, the nonce using the public key; hashing, by the second entity, the nonce; transmitting, from the second entity to the first entity, the encrypted nonce; decrypting, by the first entity, the encrypted nonce using the private key; transmitting, from the first entity to the second entity, the decrypted nonce; hashing, by the second entity, the decrypted nonce; determining, by the second entity, that the decrypted nonce hash matches the nonce hash; and verifying, based on the determination, a digital identity of the user.

### RELATED APPLICATIONS

This application claims benefit of and priority to U.S. Provisional Patent Application No. 63/641,290, titled “Secure Digital Identity (SDI)” and filed May 1, 2024, which is hereby incorporated by reference in its entirety.

### FIELD

Embodiments relate generally to cryptography, and more particularly to cryptographic techniques for identity verification.

### BACKGROUND

Identity verification involves the process of confirming that an individual, device, or entity is authentic and authorized to perform specific actions. It can be a critical component of security frameworks across various domains, including financial transactions, secure communications, access control, and digital authentication. Traditionally, identity verification has relied on at least three primary factors: knowledge-based authentication, possession-based authentication, and biometric authentication. Knowledge-based authentication involves information known only to the user, such as passwords, PINs, or security questions. Possession-based authentication generally relies on physical objects, such as ID cards, security tokens, or mobile devices, that grant access when presented. Biometric authentication employs unique physical traits, such as fingerprints, voice patterns, or retinal scans, to verify an individual's identity.

Each of these approaches has been adopted and integrated into both physical and digital security systems. Online banking services, for example, typically require a combination of passwords and two-factor authentication to verify a user's identity. Workplace security systems often implement access control mechanisms using keycards or security tokens. Smartphones and computing devices have increasingly incorporated biometric authentication, allowing users to unlock their devices and access applications using facial recognition or fingerprint scans.

### SUMMARY

With the expansion of digital ecosystems and automation, identity verification is evolving to incorporate cryptographic techniques that enhance security while improving usability and privacy. Cryptography involves securing communication and data through mathematical transformations that make information unreadable to unauthorized entities. It is often used to encrypt sensitive data, verify authenticity, and ensure secure interactions between parties. One cryptographic approach is public-key cryptography, also known as asymmetric encryption, which employs a pair of mathematically related keys. A set of cryptographic parameters, which are intended to be shared with third parties (often referred to as a “public key”), is used to encrypt data, while a corresponding set of cryptographic parameters, which are intended to be kept secure with a party (often referred to as a “private key”), is used to decrypt the information. This method allows for secure communication and authentication without requiring the transmission of sensitive credentials. Additionally, the reverse process may be used for authentication purposes: a private key can encrypt data (or a hash of the data), while the corresponding public key is used to decrypt it. This can provide digital signature functionality, where encrypting with a private key allows others to verify the authenticity and integrity of a message using the public key.

Additional cryptographic mechanisms, such as hash functions and nonces, may further strengthen identity verification processes. A hash function generally converts input data into a fixed-length digital fingerprint, ensuring data integrity and enabling tamper detection. Nonces, or single-use random values, may prevent replay attacks by ensuring that authentication challenges are unique to each session. These cryptographic techniques may be employed in various applications, including digital signatures to validate the authenticity of contracts and transactions, encrypted messaging to ensure private communication between users, blockchain networks to secure decentralized transactions, and IoT security frameworks to authenticate device interactions.

By integrating cryptographic methods into identity verification, modern security frameworks may provide stronger protection against fraud, impersonation, and unauthorized access. Such approaches may enable more robust authentication mechanisms while reducing reliance on insecure traditional methods. As digital interactions continue to expand across industries, cryptographically verifiable identity systems can be useful for ensuring the security, privacy, and trustworthiness of online and offline transactions.

Unfortunately, as digital services and autonomous systems continue to expand and become more complex, identity verification methods may face increasing security, usability, and privacy challenges. Passwords are vulnerable to theft, brute-force attacks, and phishing scams, while physical credentials such as ID cards and key fobs can be lost, cloned, or stolen. Even biometric data, once compromised, may present a permanent security risk. These issues may be exacerbated by centralized credential databases, which serve as attractive targets for cyberattacks, exposing users to identity theft and fraud. Online banking systems are frequently exploited through stolen credentials, phishing, and credential stuffing attacks, leading to unauthorized financial transactions. E-commerce platforms suffer from identity theft where attackers use compromised login credentials to make fraudulent purchases. Internet of Things (IoT) devices, which often rely on weak authentication mechanisms, are susceptible to remote hijacking, allowing attackers to gain control over smart home systems, industrial automation equipment, or connected vehicles. Data breaches at major corporations and service providers may result in the exposure of sensitive user credentials, making it easier for attackers to engage in large-scale identity fraud.

Provided are techniques that address vulnerabilities of identity verification and, in turn, may provide robust identity verification. Certain embodiments employ a cryptographically verifiable identity architecture designed to enhance security while preserving privacy, including a Secure Digital Identity (SDI) system and method. In some embodiments, the SDI techniques are built upon a Personal Cryptographic Matter (PCM) framework, a structured and encrypted identity storage mechanism that securely manages authentication keys, passphrases, and service-specific identifiers. Unlike traditional authentication methods that rely on static credentials or biometric data, SDI leverages cryptography, such as public-private key cryptography, to verify identity without exposing sensitive information. In some embodiments, during a registration process, a user or device generates a public-private key pair and registers the public key with a service provider, while keeping the private key secure. When authentication is required, the service provider system generates a cryptographic challenge in the form of a nonce (e.g., a single-use random value), encrypts the nonce with the user's public key and transmits the encrypted nonce to the user for decryption. The service provider system also generates and stores a hash of the nonce and discards the nonce. The user's agent, which may be a mobile application (or “app”), hardware security module, or other cryptographic interface, decrypts the nonce using the counterpart private key and returns the resulting decrypted nonce to the service provider. The service provider then verifies the response by hashing the decrypted nonce and comparing the resulting hash of the decrypted nonce to the stored hash of the nonce. If these match, the service provider system verifies the identity and grants the user (or the user's agent) access to associated resources. Such a process may ensure that only the rightful owner of the private key can complete the authentication process.

Embodiments of the SDI architecture may enhance security through a split knowledge security model, ensuring that cryptographic keys are not stored with service providers, thereby reducing exposure to large-scale breaches. In some embodiments, PCM structures enable users to locally maintain multiple identity keys for different services, providing enhanced privacy and interoperability across authentication platforms. For example, a user may store separate cryptographic keys for financial services, healthcare records, and IoT device authentication, each tied to a distinct identity within a single PCM matter for the user. Such an approach may eliminate reliance on shared secrets, reducing vulnerabilities associated with password reuse and credential theft, while enabling a more flexible and privacy-preserving authentication framework.

Described embodiments establish a robust identity verification system that extends beyond conventional authentication methods. In some embodiments, the SDI architecture integrates user agents, PCM services, and SDI-enabled service providers to facilitate seamless and highly secure authentication. In certain embodiments, an authentication process begins with an initial registration in which a user (or a user's agent working on behalf of the user) establishes a cryptographic identity by creating a key pair and storing the private key within a PCM package (e.g., within a PCM tree of a PCM package). The PCM package is encrypted using a passphrase (e.g., a password) known only to the user, ensuring that even if the encrypted data is intercepted, it remains inaccessible without the correct decryption credentials. The encrypted PCM package is then stored at a PCM service, which effectively acts as a secure repository based at least on the PCM service not having access to the user's private key and passphrase. When a user attempts to authenticate, the PCM service retrieves the encrypted PCM package and transmits it to the user agent for local decryption. The user agent prompts the user for their password, and then decrypt the encrypted PCM package with the password and extract the relevant authentication key, such as the private key for a service provider that is stored in a tree of information in the PCM package. The user agent then engages in a challenge-response process with the service provider, proving identity through cryptographic verification rather than relying on passwords or biometrics. This may include, for example, proving user identity through encryption and decryption of a nonce using the private and public keys for the service provider.

Certain embodiments of the SDI architecture further support identity registration with multiple service providers by allowing users to generate and manage separate cryptographic identities for different services. For example, in some embodiments, when registering with a new service, the user's agent creates a unique cryptographic key pair specific to that provider and securely adds it to the PCM package. The service provider receives only the user's public key and an anonymized identifier for that provider, ensuring that no personally identifiable information is exchanged. To verify identity, the provider issues a cryptographic challenge, which the user agent decrypts and responds to using the stored private key. The service provider completes the verification by hashing the response and comparing it to the expected hash, confirming that the user is in control of the registered identity. This process may ensure that authentication is simple, secure, and privacy-preserving, allowing users to engage with multiple services by way of a single password used to access the PCM package locally and without exposing sensitive personal data to third parties.

Embodiments of the SDI architecture may offer a significant advancement over traditional identity verification systems by implementing a decentralized, cryptographically secure authentication model. For example, by leveraging public-private key authentication, split knowledge security, and PCM-based identity storage, the described SDI techniques may reduce or eliminate the risks associated with shared secrets and centralized credential databases. Moreover, such a system may provide a scalable and flexible solution suitable for various contexts, such as financial services, IoT networks, digital transactions, enterprise authentication, and secure access control.

As described, certain embodiments may be employed in the context of secure digital authentication for financial transactions, IoT networks, and enterprise security. Although certain embodiments are described in a given context for the purpose of illustration, the techniques described herein may also be employed in any suitable context. For example, certain embodiments may be used to secure access to services (e.g., banking, rental car, or the like services), securing access to documents (e.g., personal medical records, government records, business records, or the like), authenticating users in decentralized identity frameworks, or enabling trusted interactions between autonomous systems.

### BRIEF DESCRIPTION OF THE DRAWINGS

FIG. 1 is a diagram that illustrates an identity verification environment in accordance with one or more embodiments.

FIG. 2 is a flow diagram that illustrates a method for identity verification in accordance with one or more embodiments.

FIG. 3 is a flow diagram that illustrates a method for user registration in accordance with one or more embodiments.

FIG. 4 is a flow diagram that illustrates a method for service-based identity verification in accordance with one or more embodiments.

FIGS. 5A and 5B are flow diagrams that illustrate portions of a method for service-based identity verification with a service provider in accordance with one or more embodiments.

FIG. 6 is a diagram that illustrates an example computer system in accordance with one or more embodiments.

While this disclosure is susceptible to various modifications and alternative forms, specific example embodiments are shown and described. The drawings may not be to scale. The drawings and the detailed description are not intended to limit the disclosure to the form disclosed, but are intended to disclose modifications, equivalents, and alternatives falling within the spirit and scope of the present disclosure as defined by the claims.

### DETAILED DESCRIPTION

Described are embodiments for identity verification. Provided are techniques that address vulnerabilities of identity verification and, in turn, may provide robust identity verification. Certain embodiments employ a cryptographically verifiable identity architecture designed to enhance security while preserving privacy, including a Secure Digital Identity (SDI) system and method. In some embodiments, the SDI techniques are built upon a Personal Cryptographic Matter (PCM) framework, a structured and encrypted identity storage mechanism that securely manages authentication keys, passphrases, and service-specific identifiers. Unlike traditional authentication methods that rely on static credentials or biometric data, SDI leverages cryptography, such as public-private key cryptography, to verify identity without exposing sensitive information. In some embodiments, during a registration process, a user or device generates a public-private key pair and registers the public key with a service provider, while keeping the private key secure. When authentication is required, the service provider system generates a cryptographic challenge in the form of a nonce (e.g., a single-use random value), encrypts the nonce with the user's public key and transmits the encrypted nonce to the user for decryption. The service provider system also generates and stores a hash of the nonce and discards the nonce. The user's agent, which may be a mobile application (or “app”), hardware security module, or other cryptographic interface, decrypts the nonce using the counterpart private key and returns the resulting decrypted nonce to the service provider. The service provider then verifies the response by hashing the decrypted nonce and comparing the resulting hash of the decrypted nonce to the stored hash of the nonce. If these match, the service provider system verifies the identity and grants the user (or the user's agent) access to associated resources. Such a process may ensure that only the rightful owner of the private key can complete the authentication process.

Embodiments of the SDI architecture may enhance security through a split knowledge security model, ensuring that cryptographic keys are not stored with service providers, thereby reducing exposure to large-scale breaches. In some embodiments, PCM structures enable users to locally maintain multiple identity keys for different services, providing enhanced privacy and interoperability across authentication platforms. For example, a user may store separate cryptographic keys for financial services, healthcare records, and IoT device authentication, each tied to a distinct identity within a single PCM matter for the user. Such an approach may eliminate reliance on shared secrets, reducing vulnerabilities associated with password reuse and credential theft, while enabling a more flexible and privacy-preserving authentication framework.

Described embodiments establish a robust identity verification system that extends beyond conventional authentication methods. In some embodiments, the SDI architecture integrates user agents, PCM services, and SDI-enabled service providers to facilitate seamless and highly secure authentication. In certain embodiments, an authentication process begins with an initial registration in which a user (or a user's agent working on behalf of the user) establishes a cryptographic identity by creating a key pair and storing the private key within a PCM package (e.g., within a PCM tree of a PCM package). The PCM package is encrypted using a passphrase (e.g., a password) known only to the user, ensuring that even if the encrypted data is intercepted, it remains inaccessible without the correct decryption credentials. The encrypted PCM package is then stored at a PCM service, which effectively acts as a secure repository based at least on the PCM service not having access to the user's private key and passphrase. When a user attempts to authenticate, the PCM service retrieves the encrypted PCM package and transmits it to the user agent for local decryption. The user agent prompts the user for their password, and then decrypt the encrypted PCM package with the password and extract the relevant authentication key, such as the private key for a service provider that is stored in a tree of information in the PCM package. The user agent then engages in a challenge-response process with the service provider, proving identity through cryptographic verification rather than relying on passwords or biometrics. This may include, for example, proving user identity through encryption and decryption of a nonce using the private and public keys for the service provider.

Certain embodiments of the SDI architecture further support identity registration with multiple service providers by allowing users to generate and manage separate cryptographic identities for different services. For example, in some embodiments, when registering with a new service, the user's agent creates a unique cryptographic key pair specific to that provider and securely adds it to the PCM package. The service provider receives only the user's public key and an anonymized identifier for that provider, ensuring that no personally identifiable information is exchanged. To verify identity, the provider issues a cryptographic challenge, which the user agent decrypts and responds to using the stored private key. The service provider completes the verification by hashing the response and comparing it to the expected hash, confirming that the user is in control of the registered identity. This process may ensure that authentication is simple, secure, and privacy-preserving, allowing users to engage with multiple services by way of a single password used to access the PCM package locally and without exposing sensitive personal data to third parties.

Embodiments of the SDI architecture may offer a significant advancement over traditional identity verification systems by implementing a decentralized, cryptographically secure authentication model. For example, by leveraging public-private key authentication, split knowledge security, and PCM-based identity storage, the described SDI techniques may reduce or eliminate the risks associated with shared secrets and centralized credential databases. Moreover, such a system may provide a scalable and flexible solution suitable for various contexts, such as financial services, IoT networks, digital transactions, enterprise authentication, and secure access control.

As described, certain embodiments may be employed in the context of secure digital authentication for financial transactions, IoT networks, and enterprise security. Although certain embodiments are described in a given context for the purpose of illustration, the techniques described herein may also be employed in any suitable context. For example, certain embodiments may be used to secure access to services (e.g., banking, rental car, or the like services), securing access to documents (e.g., personal medical records, government records, business records, or the like), authenticating users in decentralized identity frameworks, or enabling trusted interactions between autonomous systems.

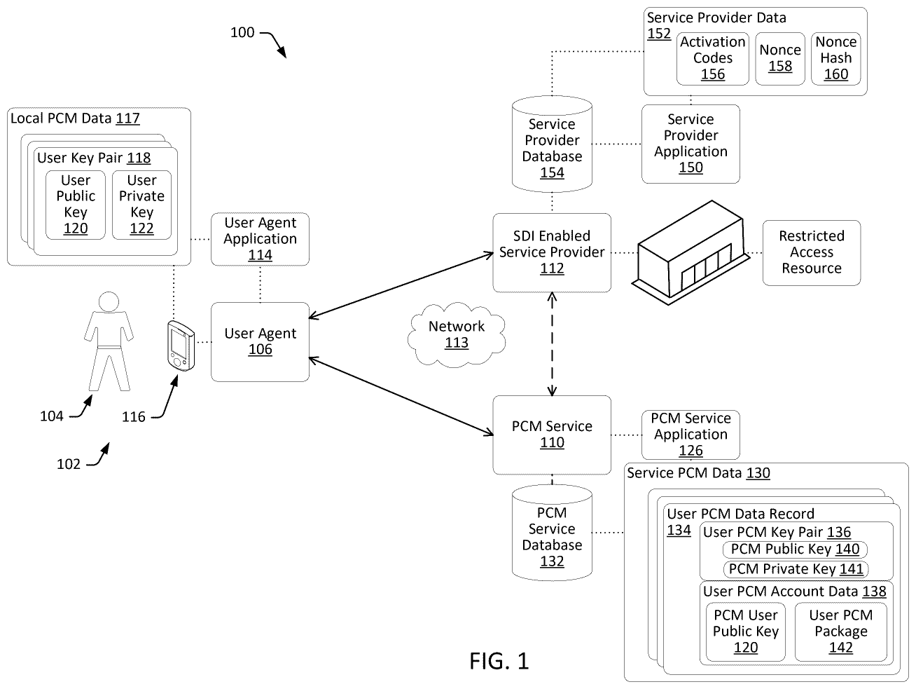

FIG. 1 is a diagram that illustrates an identity verification system 100 in accordance with one or more embodiments. In the illustrated embodiment, system 100 includes a user system 102, which includes a user 104 and a user agent 106, a PCM service system (or “PCM service”) 110, and a secure digital identity (SDI) SDI-enabled service provider (or “service provider”) 112, which are communicatively coupled by way of an electronic communications network 113, such as the Internet, a wide area network (WAN), a local area network (LAN), or the like.

In some embodiments, the user 104 is a person or other entity for which an identity is to be verified. For example, the user 104 may be a person named Mike Smith, who is seeking to verify his identity with a third party, such as a bank-type service provider 112, in an effort to gain access to a resource held by the third party, such as his bank account records or to conduct associated financial transactions.

In some embodiments, the user agent 106 includes a software application that facilitates identity verification of a user. For example, the user agent 106 may be a user identity verification application 114 stored and executed locally on a user device 116 associated with user 104. Continuing with the above, the user agent 106 may include the same application 114 stored and executed locally on a smartphone-type user device 116 used by or otherwise associated with Mike Smith. Operations described as being performed by the user agent 106 may, for example, be executed by the user identity verification application 114 associated with the user agent 106.

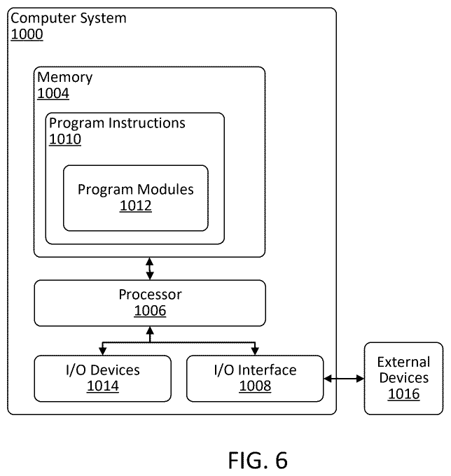

In some embodiments, the user device 116 is a computing device that is associated with a user. For example, the user device 116 may be a smartphone, smartwatch, tablet computer, personal computer, server, or similar computing system that is managed by, or otherwise associated with, the user 104. Continuing with the above, the user device 116 may be a smartphone used by or otherwise associated with Mike Smith. In such an embodiment, user identity verification application 114 may execute on the computing system of the user device 116 to perform the described operations of the user agent 106. In some embodiments, the user device 116 includes a computer system that is the same or similar to computer system 1000 described with regard to at least FIG. 6.

In some embodiments, the user identity verification application 114 is operable to generate and store user PCM data 117 locally. This may include one or more user cryptographic key pairs (“user key pairs”) 118 associated with one or more service providers 112 or the like. Each of the user key pairs 118 may include a respective user public key 120 and corresponding user private key 122. For example, locally stored user PCM data 117 may include, for each of several different service providers 112 (e.g., a bank, a rental car service, a shopping service, or the like) accessed by Mike Smith through his smartphone, a unique user key pair 118, including a user public key 120 and corresponding user private key 122, for the service provider 112. As described each user private key 122 may be cryptographic parameters held in confidence by the user agent 106 (e.g., stored in local memory of the user device 116) or within service PCM data 130, such as a user PCM data record 134, maintained by the PCM service 110 in a PCM service database 132. For each user private key 122, the corresponding user public key 120 may be distributed to one or more third parties, such as the corresponding service provider 112. A user private key 122 may, for example, be retrieved and used by the user agent 106 to verify the user's identity by way of decrypting data, such as a nonce, encrypted by a service provider 112 using the corresponding public key 120.

In some embodiments, the PCM service 110 is an entity operable to manage data associated with users. For example, the PCM service 110 may execute a PCM service application 126 that manages the creation, modification, implementation, and deletion of service PCM data 130 for various users, including the user 104. As described, users, service providers, or other entities may subscribe or otherwise utilize the PCM service 110 to secure relevant encryption data and coordinate identity verification between users, service providers, or other entities. Operations described as being performed by the PCM service 110 may, for example, be executed by the PCM service application 126 associated with the user agent 106.

In some embodiments, the PCM service 110 includes a computing device. For example, the PCM service 110 may include a server or similar computing system that is operated by the PCM service 110, and that stores and manages associated service PCM data 130 in an associated PCM database 132. In such an embodiment, the PCM service application 126 may execute on the computing system of the PCM service 110 to perform the described operations of the PCM service 110. In some embodiments, the PCM service 110 includes a computer system that is the same or similar to the computer system 1000 described with regard to at least FIG. 6.

In some embodiments, the service PCM data 130 includes a respective user PCM data record 134 for each of different users, including the user 104. Each user PCM data record 134 may include a unique user PCM key pair 136 for the associated user, and a set of user PCM account data 138 for the associated user. For example, the service PCM data 130 may include a respective user PCM data record 134 for each of different users, including a user PCM data record 134 for Mike Smith that includes a PCM key pair 136 for Mike Smith's PCM account, and a set of user PCM account data 138 for Mike Smith. The user PCM account data 138 for a user may include, for example, registration data for the user (e.g., login name, email address, and the like), a PCM public key 140 of the PCM key pair 136 for the associated user (a “user PCM service public key”—a counterpart to a PCM private key 141 of the PCM key pair 136), and a user PCM package 142. As described, the PCM service 110 may generate a unique PCM key pair 136 for each user. As a result, each user may be assigned or otherwise associated with a unique PCM key pair 136 that can be used to verify the identity of the user. As described, the user PCM package 142 for a user may include a tree package (a “PCM tree package”) for the user, including a listing of the one or more user key pairs 118 for various service providers 112 and associated information for the user, which may be stored in expandable or non-expandable formats such as an editable (or “writeable”) PCM tree and a read-only authentication tree. In some embodiments, the user PCM package 142 is generated and encrypted by the user agent 106 using a secret, such as a user provided passphrase. For example, user PCM account data 138 for Mike Smith may include a PCM public key 140 associated with Mike Smith's account and a user PCM package 142 that is encrypted using a passphrase (e.g., “BlueSky #2024”) provided by Mike Smith and that includes, for each of several different service providers 112 (e.g., a bank, a rental car service, shopping service, or the like) enlisted by Mike Smith, the unique user key pair 118, including the user public key 120 and corresponding user private key 122, for the service provider 112. In such an embodiment, the user PCM package 142 may be retrieved from the PCM service 110 by the user agent 106, be decrypted by the user agent 106 using a user supplied passphrase (e.g., “BlueSky #2024”), and the user agent 106 may access the user private key 122 for a service provider 112 (e.g., the user private key 122 for the bank) to verify its identity to the service provider 112 (e.g., the bank) by way of decrypting data, such as a nonce, encrypted by the service provider 112 using the corresponding public key 120 (e.g., the user public key 120 for the bank).

In some embodiments, the service provider 112 is an entity operable to provide restricted access to resources. For example, the service provider 112 may execute a service provider application 150 that manages user access to data (e.g., electronic documents, such as electronic medical records (EM Rs)), services, access or use of physical items (e.g., unlock a door, start/operate a vehicle, operate an industrial machine, or the like), or the like. Continuing with the above, the service provider 112 may be a bank at which Mike Smith has an account and may operate an online banking application that provides restricted access to Mike Smith's bank resources, including his bank account records and his ability to conduct associated financial transactions with the account. Operations described as being performed by the service provider 112 may, for example, be executed by the service provider application 150 associated with the service provider 112.

In some embodiments, the service provider 112 includes a computing device. For example, the service provider 112 may include a server or a similar computing system that is operated by the service provider 112, and that stores and manages associated service provider data 152 in an associated service provider database 154. In such an embodiment, the service provider application 150 may execute on the computing system of the service provider 112 to perform the described operations of the service provider 112. In some embodiments, the service provider 112 includes a computer system that is the same or similar to the computer system 1000 described with regard to at least FIG. 6.

In some embodiments, the service provider data 152 includes data for use in transacting with users 104 and the PCM service 110. For example, the service provider data 152 may include activation codes 156, nonces 158, and associated nonce hashes 160 (e.g., generated in verification procedures), and the like. As described, in some embodiments, the nonce hashes 160 are stored for later comparison, but the corresponding nonces 158 are not retained in an effort to increase the security of the generated nonce hashes 160 and the validation process. Continuing with the above, where the service provider 112 is the bank and Mike Smith is requesting access to banking records and services, the service provider application 150 may, in response to a corresponding access request from the user agent 106 for Mike Smith, provide an activation code 156 to the user agent 106 for use in verifying/identifying the existence of the transaction with the service provider 112, generate a nonce 158 (e.g., a randomly generated byte array) and hash it to generate a nonce hash 160, encrypt the nonce 158 using a user public key 120 associated with Mike Smith (e.g., provided to the bank system in a registration process) to generate an encrypted version of the nonce 158 (e.g., a public encrypted nonce), send the encrypted version of the nonce 158 to the user agent 106 for Mike Smith, discard the nonce 158 (and the encrypted version of the nonce 158) and store the nonce hash 160 in the service provider database 154 or other location, and, in response to receiving a decrypted version of the nonce 158 (e.g., a private decrypted nonce) from the user agent 106 for Mike Smith, compare the decrypted version to the stored nonce hash 160 to verify the identity of the user agent 106 and Mike Smith, and, in turn, provide the user agent 106 (and in turn the user device 116 or other applications associated with Mike Smith, such as the bank's banking application executing on the user device 116) with access to the requested banking services.

In some embodiments, a key pair includes two mathematically linked cryptographic parameters: a cryptographic public key (or “public key”) and a cryptographic private key (or “private key”). These parameters may be used in asymmetric encryption to provide security and authentication. In some instances, the public key is shared (e.g., shared openly or with limited persons or entities) and is used for encryption, while the private key is kept secret (e.g., held in confidence, not shared with other persons or entities) and is used for decryption. This can ensure that only the entity in possession of the private key can decrypt information that has been encrypted with the corresponding public key. For example, Mike Smith may register for a Secure Digital Identity (SDI) service with his bank. His user identity verification application 114 may then generate a key pair: Public Key: M 5PK 123-PUB (shared with the bank for authentication); Private Key: M 5PK 123-PRIV (stored securely on Mike's device). When Mike attempts to log into his bank account, the bank encrypts a randomly generated nonce with his public key as follows: ENC_RSA (Nonce, M 5PK 123-PUB)=e9f1d5c7a3b2 . . . , and provides the encrypted nonce to Mike's app which Mike's mobile app decrypts using his private key to retrieve the nonce, proving that he holds the private key and, thereby, proving his identity.

In some embodiments, a nonce (Number Used Once) is a unique, random value generated during authentication to prevent replay attacks. Each nonce may be used once per session, ensuring that even if a previous authentication attempt is intercepted, it cannot be reused maliciously. For example, when Mike logs into his bank, the bank server generates a unique nonce: Nonce: b4f7a9c3. The bank encrypts the nonce using Mike's public key as follows: ENC_RSA (b4f7a9c3, M 5PK 123-PUB)=e9f1d5c7a3b2 . . . , and Mike's mobile app decrypts the encrypted nonce with his private key and sends the decrypted nonce back to the bank. The bank verifies the received decrypted nonce value (e.g., by comparing the hash of the nonce and the hash of the decrypted nonce value to ensure they match), confirming that Mike (or at least the user agent) holds the private key and, thereby, proving Mike's (or the associated user agent's) identity.

In some embodiments, a hash is a fixed-length digital fingerprint of input data, generated using a cryptographic hash function. Hashing can ensure data integrity, making it easy to verify whether data has been tampered with. For example, Mike's bank may generate the following nonce for authentication: Nonce: b4f7a9c3. Before encrypting it, the bank hashes the nonce using SHA-256 as follows: HASH_SHA 256 (b4f7a9c3)=6d3a5f9e8b47c2elf0a4 . . . . As described, when Mike decrypts the nonce and sends it back, the bank hashes the received value and compares it to the stored hash to verify his identity.

In some embodiments, a Personal Cryptographic Matter (PCM) is a structured and encrypted storage mechanism that maintains a user's cryptographic keys, authentication credentials, and service-specific identifiers. It may be used to ensure that only the legitimate user can access or modify stored data. PCM is designed using split knowledge security, meaning that only the user can decrypt the stored cryptographic material using a passphrase-protected encryption scheme. A PCM package may include a structured storage format that securely organizes multiple cryptographic key pairs and service records. A PCM package may include, for example, the following: header information, which identifies the PCM uniquely and includes the user's public key, a PCM tree structure that defines relevant PCM data such as service provider key pairs, and encryption and security information, which identifies how the PCM package is encrypted (e.g., using AES-256 with a user-provided passphrase to ensure security and prevent unauthorized access). A PCM package may include an expandable version of the PCM package that includes a modifiable (e.g., an editable) structure, such as a modifiable PCM tree structure, that allows users to store and manage cryptographic key pairs for different services. A PCM package may include a fixed version of the PCM package that includes an unmodifiable (e.g., a read-only) version of the PCM package that includes a non-editable, read-only PCM tree structure, that remains immutable for use in authentications, where edits are not desirable. For example, Mike Smith's PCM package may include the following:

### Header Information:

Unique PCM Identifier (e.g., PCM-USER-098A)
User's Public Key for PCM Encryption (e.g., PCM-PK-098A) Expandable/Fixed PCM Tree:
Banking Service Key Pair (e.g., BANK-PK-789X/BANK-PRIV-789X)
Shopping Service Key Pair (e.g., SHOP-PK-456Y/SHOP-PRIV-456Y)
Car rental service Key Pair (e.g., CAR-PK-678Z/CAR-PRIV-678Z) Encryption and Security Information:
Encrypted using AES-256 with user passphrase

Here, Mike's PCM package may be encrypted using AES-256 with a passphrase known only to him, such as “BlueSky #2024” to generate an encrypted version of the PCM package (e.g., an encrypted PCM package). Further, it may be securely stored on the PCM service 110 but the data it contains may remain accessible only via his user agent 106 using his passphrase. Where the PCM package is stored in a format that includes an expandable (e.g., editable) PCM tree, the PCM package may be referred to as an expandable version of the PCM package. Where the PCM package is stored in a format that includes a non-expandable (non-editable) PCM tree, the PCM package may be referred to as a fixed or non-expandable version of the PCM package.

An example PCM creation and initialization process may include the following:
Step 1: User requests PCM creation (e.g., Mike Smith registers for a PCM account via an SDI-enabled service provider);
Step 2: PCM service issues an activation code (e.g., Mike's bank provides an activation code ACT-1A 34R FT);
Step 3: User agent generates a public-private key pair for PCM (e.g., Mike's mobile app generates an RSA-2048 key pair for the PCM, including a public key (PCM-PK-098A) for the PCM service which will be provided to the PCM service for its storage and use in verifications with Mike);
Step 4: PCM service creates the user PCM account (e.g., the PCM service registers Mike's unique PCM ID and associates Mike's public key (PCM-PK-098A) with the account);
Step 5: User agent creates an expandable PCM package (e.g., Mike's app generates service-specific key pairs for banking and shopping accounts and edits a tree structure of an expandable PCM package for Mike to include the service-specific key pairs);
Step 6: User agent encrypts the PCM package using the user's passphrase (e.g., Mike's app encrypts the PCM package using AES-256 with passphrase BlueSky #2024 and sends the encrypted PCM package to the PCM service); and
Step 7: PCM service stores the PCM package in expanded and fixed formats (e.g., the PCM service stores both an expandable PCM package and a fixed PCM package in PCM account data for Mike, which includes Mike's registration data, his public key for the PCM service (PCM-PK-098A), his encrypted PCM package (e.g., including both the expandable and fixed versions of the PCM package), and a unique user PCM key pair that the PCM service generates for use with Mike's account).

An example PCM retrieval and use process may include the following:
Step 1: User requests access to PCM (e.g., Mike attempts to log into his bank using SDI authentication and Mike's app provides to the PCM service Mike's login identifier as a request to access his PCM account and PCM package, for use in retrieving Mike's private key for verifying his identity with the bank).
Step 2: PCM service verifies Mike's login identifier and retrieves/provides encrypted PCM package and public encrypted nonce (e.g., the PCM Service validates Mike's login identifier and retrieves his encrypted fixed PCM package and provides it to Mike's app, along with an encrypted version of the nonce-encrypted using Mike's public key (PCM-PK-098A) for the PCM service—and also stores a hash of the nonce);
Step 3: User agent requests passphrase and decrypts PCM (e.g., Mike's app request that he enter his passphrase for the PCM package, and Mike enters “BlueSky #2024,” allowing his app to decrypt the fixed PCM package and access the private key for the PCM service.);
Step 4: User agent decrypts nonce (e.g., Mike's app decrypts the encrypted version of the nonce to generate a “private-decrypted” version of the nonce, that it provides to the PCM service).
Step 5: PCM verifies the decrypted nonce and provide expandable PCM package (e.g., the PCM service hashes the “private-decrypted” version of the nonce and compares to the stored hash of the nonce to verify that they match, and, in response, sends the expandable version of the PCM package to Mike's app for decryption and use).
Step 6: User agent retrieves the required private key for authentication (e.g., Mike's app decrypts the expandable version of the PCM package using his passphrase (BlueSky #2024) and retrieves the banking private key (BANK-PRIV-789X) from the PCM tree of the decrypted, expandable PCM package);
Step 7: User agent uses private key for secure authentication (e.g., Mike's app completes a nonce challenge using the banking private key (BANK-PRIV-789X), such as by decrypting a public-encrypted nonce that was encrypted using the banking public key (BANK-PK-789X)).

As described, the PCM may provide a split knowledge security model, ensuring that: the user PCM passphrase is never shared (e.g., the PCM Service never knows the user's decryption key); the PCM service cannot access the private keys (e.g., only the user agent can decrypt and retrieve private keys; and authentication happens locally (e.g., the user agent, not the PCM service, handles cryptographic operations). Additionally, the PCM service 110 and the SDI-enabled service 112 may be physically separate, so the private key and the associated resource are not in the same physical location.

An example PCM Updates and Key Management process may include the following:
Step 1: User requests to add a new service (e.g., Mike registers his SDI with a Car rental service);
Step 2: User agent generates a new key pair for the service (e.g., Mike's app generates a service key pair (CAR-PK-678Z and CAR-PRIV-678Z) for the car rental service);
Step 3: User agent updates the PCM package with new service keys (e.g., Mike's app requests, retrieves, and decrypts the expandable PCM package, e.g., as noted in the prior example, and modifies the service key pair(s) in the tree of the expandable PCM package to include the service key pair (CAR-PK-678Z and CAR-PRIV-678Z) for the car rental service);
Step 4: User agent encrypts the updated PCM package using the user's passphrase (e.g., Mike's app encrypts the modified PCM package using his passphrase (with AES-256 using BlueSky #2024) to generate an encrypted version of Mike's modified PCM package); and
Step 5: Updated PCM package is sent to PCM service (e.g., Mike's app sends the encrypted version of Mike's modified PCM package to the PCM service (e.g., including an encrypted versions of each of the fixed and expandable versions of the PCM package), which stores the encrypted version of Mike's modified PCM package for safekeeping).

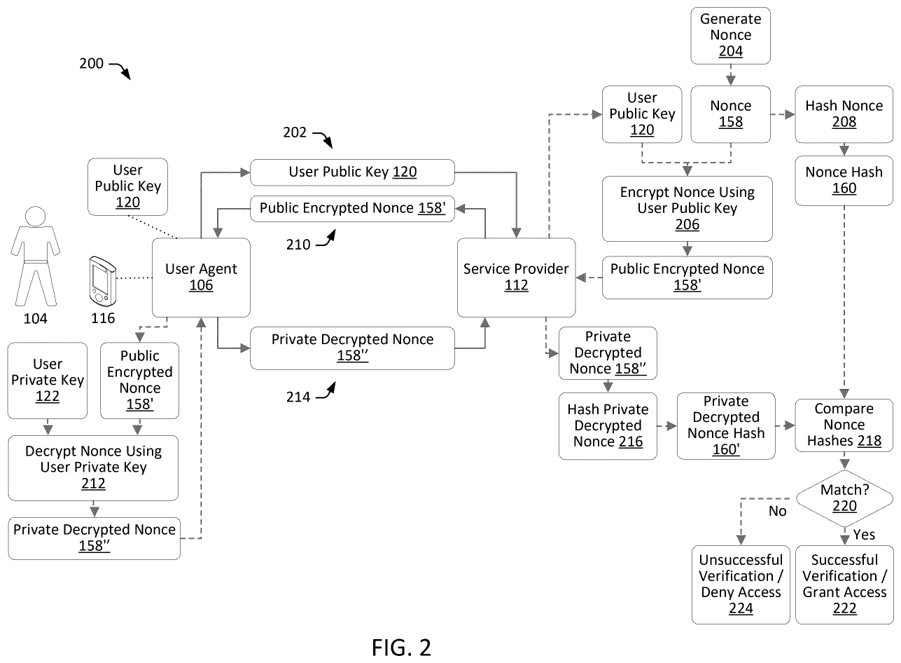

FIG. 2 is a flow diagram that illustrates a method 200 of identity verification in accordance with one or more embodiments. Some or all of the procedural elements of method 200 may be performed, for example, by one or more entities of the identity verification system 100 or another entity. For example, some or all of the operations of method 200 may be performed by the user agent 106, the PCM service 110, the SDI-enabled service provider 112, or the user 104. Embodiments of method 200 may ensure secure authentication by leveraging asymmetric encryption, cryptographic hashing, and challenge-response validation mechanisms.

In the illustrated embodiment, at step 202, the user agent 106 (a first entity) provides a user public key 120 to the service provider 112 (a second entity). For example, during a registration process, Mike Smith's app 114 registers his public key (M 5PK 123-PUB) with his bank's authentication system, which stores the public key for future verification.

At step 204, the service provider 112 generates a nonce 158 for authentication. For example, the bank generates a unique nonce (b4f7a9c3) for a current authentication session with Mike Smith and his app 114. As described, the nonce 158 may be a random, single-use value that prevents replay attacks by ensuring that authentication challenges are unique to each session.

At step 206, the service provider 112 encrypts the nonce 158 using the user's public key 120 to generate a public encrypted nonce 158′. For example, the bank encrypts the nonce (b4f7a9c3) using RSA-2048 encryption as follows: ENC_RSA (b4f7a9c3, M 5PK 123-PUB)=e9f1d5c7a3b2 . . . . This encryption may ensure that only the intended recipient, who possesses the corresponding private key, here Mike's app 114, can decrypt and retrieve the original nonce (b4f7a9c3) from the encrypted nonce (e9fld5c7a3b2 . . . ).

At step 208, the service provider 112 hashes the nonce 158 to generate a hash of the original nonce, a nonce hash 160. This may also include storing the nonce hash 160 (e.g., in a memory of the service provider 112 for later comparison) and discarding the plaintext original nonce 158. This may prevent unauthorized recovery of the nonce 158 while still allowing verification. The hashing process may be performed using a secure cryptographic hash function, such as SHA-256, as follows: HASH_SHA 256 (b4f7a9c3)=6d3a5f9e8b47c2elf0a4 . . .

At step 210, the service provider 112 transmits the public encrypted nonce 158′ to the user agent 106, and the user agent 106 receives this encrypted nonce as part of the authentication challenge. For example, Mike's app 114 receives the encrypted nonce (e9fld5c7a3b2 . . . ) from the service provider 112.

At step 212, the user agent 106 decrypts the public encrypted nonce 158′ using the corresponding user private key 122 to generate a corresponding private decrypted nonce 158″. For example, Mike's mobile app 114 uses his private key (M 5PK 123-PRIV) to decrypt the nonce as follows: DEC_RSA (e9f1d5c7a3b2 . . . , M 5PK 123-PRIV)=b4f7a9c3.

At step 214, the user agent 106 transmits the private decrypted nonce 158″ back to the service provider 112 as proof of identity. For example, Mike's app 114 sends the private decrypted nonce (b4f7a9c3) to the service provider 112.

At step 216, the service provider 112 hashes the received private decrypted nonce 158″ to generate a private decrypted nonce hash (a “hashed decrypted nonce”) 160′. For example, the bank makes the following hash determination: HASH_SHA 256 (b4f7a9c3)=6d3a5f9e8b47c2elf0a4 . . .

At step 218, the service provider 112 compares the private decrypted nonce hash 160′ to the stored nonce hash 160. For example, the bank compares the stored nonce hash (6d3a5f9e8b47c2elf0a4 . . . ) to the private decrypted nonce hash (6d3a5f9e8b47c2elf0a4 . . . ) to determine whether they match.

At step 220, if the value of the private decrypted nonce hash 160′ matches the value of the originally stored nonce hash 160, the identity verification is deemed verified (or “successful”). For example, if the bank determines that both the stored nonce hash and the private decrypted nonce hash have the same value (6d3a5f9e8b47c2elf0a4 . . . ) (e.g., the computed hash matches the stored hash), the authentication process is verified. If the value of the private decrypted nonce hash 160′ does not match the value of the originally stored nonce hash 160, the identity verification is deemed not verified (or “unsuccessful”). For example, if the bank determines that the stored nonce hash and the private decrypted nonce hash do not have the same value (e.g., the computed hash does not match the stored hash), the authentication process is not verified.

At step 222, upon successful verification, the service provider 112 grants access to the user 104. For example, the bank allows Mike to log into his online banking portal and access his account securely. At step 224, upon unsuccessful verification, the service provider 112 denies access to the user 104. For example, the bank would not allow Mike to log into his online banking portal and access his account securely.

By implementing this method, identity verification can be conducted securely without transmitting sensitive credentials, reducing the risk of credential theft and replay attacks. This cryptographic challenge-response mechanism ensures that only the rightful owner of the private key can authenticate successfully.

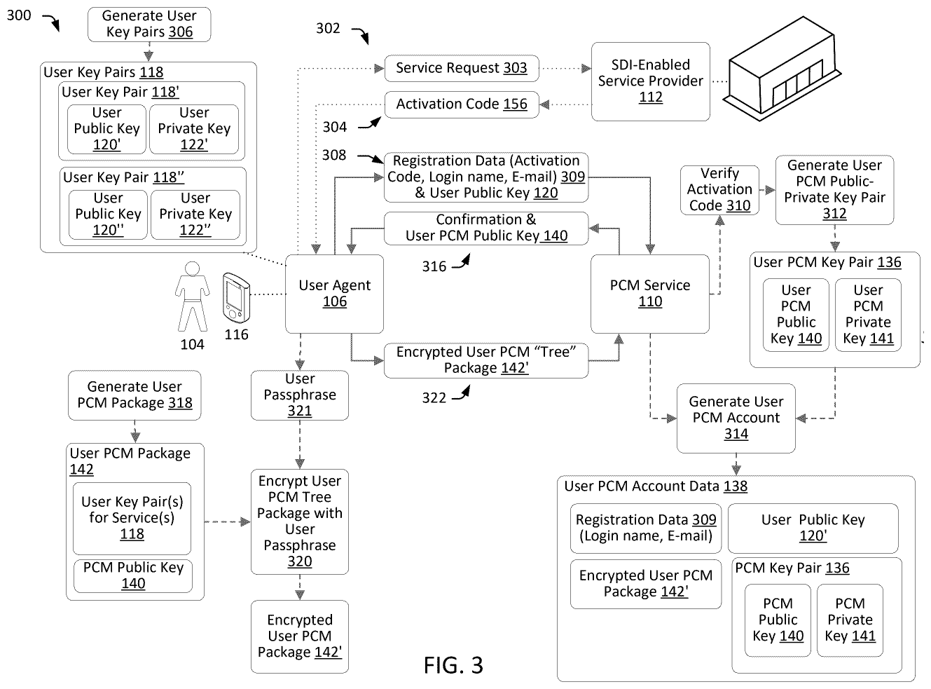

FIG. 3 is a flow diagram that illustrates a method 300 of user registration in accordance with one or more embodiments. Some or all of the procedural elements of method 300 may be performed, for example, by one or more entities of identity verification system 100 or another entity. For example, some or all of the operations of method 300 may be performed by the user agent 106, the PCM service 110, the SDI-enabled service provider 112, or the user 104. Embodiments of method 300 may facilitate the secure generation, encryption, and storage of cryptographic credentials within a PCM service. The registration process may ensure that a user can authenticate securely without relying on traditional password-based authentication mechanisms.

In the illustrated embodiment, at step 302, the user agent 106 (first entity) initiates a service request 303 with an SDI-enabled service provider 112 (third entity) to register for authentication. For example, Mike Smith uses a banking app on his device 106 to request creation of an online banking account with his bank.

At step 304, the service provider 112 generates and issues an activation code 156 to the user agent 106. For example, the bank provides the activation code “ACT-1A 34RFT” to Mike Smith's device 106, which is received by Mike's agent app 114 and will be used to verify and authenticate Mike Smith's registration.

At step 306, the user agent 106 generates a cryptographic user key pairs 118 for use with the PCM service 110 and for use with the SDI-enabled service provider 112, which each includes a respective user public key 120 and a corresponding user private key 122 for the associated service. For example, Mike's app 114 generates a “PCM” user key pair 118′ that includes: a “PCM” User Public Key PCM-PK-098A (“PCM” user public key 120′ to be shared with the PCM service 110); and a “PCM” User Private Key PCM-PRIV-098A (“PCM” user private key 122′ to be stored securely at the user agent 106). And Mike's app 114 generates a “bank” user key pair 118″ that includes: a “bank” user public key: BANK-PK-789X (a “bank” user public key 120″ to be shared with the bank); and a “bank” user private key: BANK-PRIV-789X (a “bank” user private key 122″ to be stored securely at the user agent 106).

At step 308, the user agent 106 transmits the PCM user public key 120′ and registration data 309 (including the activation code 156 and user identification information, such as an email or login ID) to the PCM service 110 (second entity). For example, Mike's app 114 sends the PCM user public key (PCM-PK-098A), the activation code (ACT-1A 34RFT), his email (mike.smith@ email.com), and his desired login name: mikesmith2024, to the PCM service 110 for registration.

At step 310, the PCM service 110 verifies the activation code 156 before proceeding. This may include communicating with the SDI-enabled service provider 112 to confirm the activation code 156 or comparing the activation code 156 against a local listing of valid activation codes. The service provider 112 and the PCM service may belong to the same organization or be separate organizations.

At step 312, upon successful verification, the PCM service 110 generates a unique user PCM key pair 136 for the user's PCM account, including a user PCM public key 140 and a user PCM private key 141 for the user 104. This may include generating a user PCM public key (UPCM-PK-098A) and a user PCM private key (UPCM-PRIV-098A) that is uniquely associated with Mike's account.

At step 314, the PCM service 110 generates a user PCM account and associates the user's relevant data with the account. For example, the PCM service 110 stores Mike's PCM user public key 120′ (PCM-PK-098A), the user PCM key pair 136 for Mike (UPCM-PK-098A/UPCM-PRIV-098A), Mike's registration data 309, and associated metadata securely in Mike's user PCM account data 138.

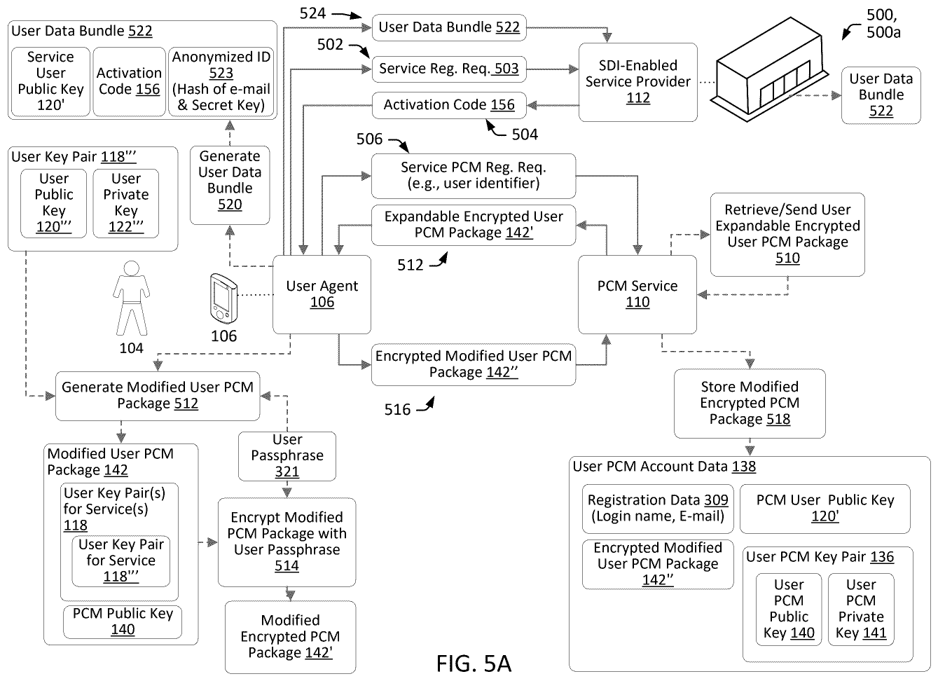

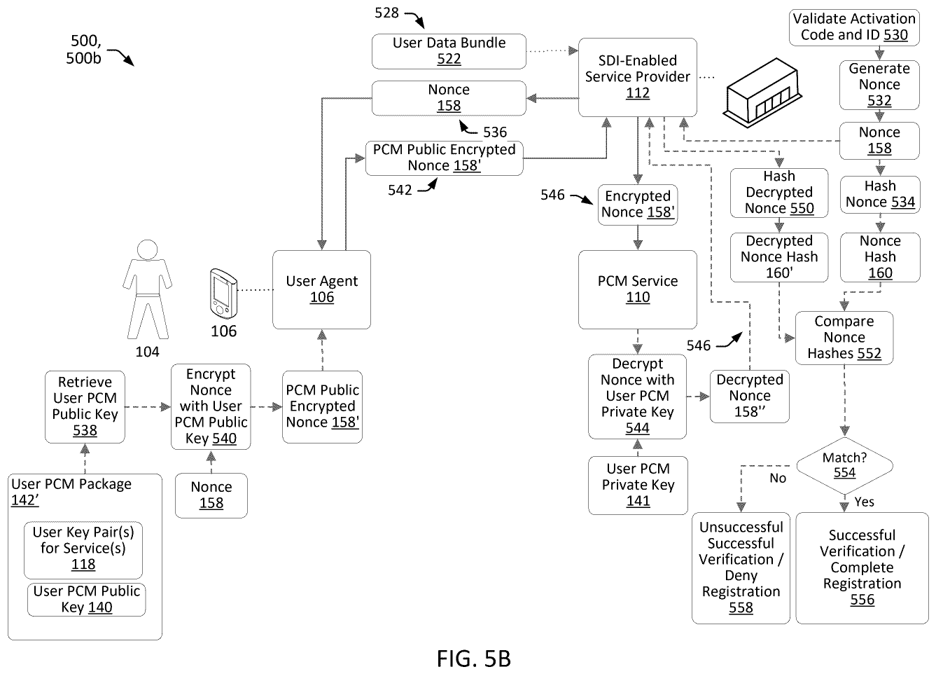

At step 316, the PCM service 110 sends a confirmation of initiation of the account, along with the user PCM public key 140 for the user 104. For example, the PCM service 110 sends Mike's user PCM public key 140 (UPCM-PK-098A) to Mike's app 114. The PCM public key 140 may be stored by the user agent 106 and utilized by the app 114 for subsequent interactions with the PCM service 110, such as the nonce challenges procedures described in FIG. 5B.

At step 318, the user agent 106 generates a PCM package 142 that securely organizes cryptographic credentials for one or more service providers 112. For example, Mike's app 114 may generate Mike Smith's PCM package, including a tree with the following tree:

Banking Service Key Pair: BANK-PK-789X/BANK-PRIV-789X; Shopping Service Key Pair: SHOP-PK-456Y/SHOP-PRIV-456Y; and PCM Service Key Pair: PCM-PK-098A/PCM-PRIV-098A.

Where a PCM package exists, generating a PCM package 142 may include adding, deleting or modifying data in the PCM package, such as adding, deleting or modifying user key pairs for service providers in the tree of the package, and adding, deleting or modifying the PCM public key 140 to the tree or other portion of the package.

At step 320, the user agent 106 encrypts the PCM package with a user-defined passphrase 321 to create an encrypted user PCM package 142′. For example, Mike Smith's app 114 may request a passphrase, Mike Smith may provide the phrase “BlueSky #2024”, and the app 114 encrypts the PCM package 142 using AES-256 with the user-defined passphrase (BlueSky #2024): ENC_AES256 (PCM-Pkg, BlueSky #2024)=A 7B 9F2C8D 3E5 . . . , to generate an encrypted PCM package 142′. The encryption process may ensure that even if an encrypted PCM package is intercepted, it remains inaccessible without the correct decryption credentials. The encrypted PCM package 142′ may include both an expandable version of the PCM package 142 (for future updates) and a fixed version of the encrypted PCM package 142 (for authentication purposes). These may be separately accessible, so that the PCM service 110 can access and send these separately, such as for subsequent authentications or modifications, as described. For example, an expandable version of the PCM package 142 may be encrypted using the passphrase 321 to generate an encrypted expandable version of the PCM package 142, and a fixed version of the PCM package 142 may be encrypted using the passphrase 321 to generate an encrypted fixed version of the PCM package 142, and the encrypted PCM package 142′ may include both.

At step 322, the user agent 106 transmits the encrypted PCM package 142′ to the PCM service 110 for secure storage, where the PCM service 110 stores and maintains the encrypted PCM package 142′. For example, the PCM service 110 may store Mike's encrypted PCM package 142′ in Mike's PCM account data 138, including both the encrypted expandable version and the encrypted fixed version of the PCM package 142. The PCM service 110 may, in turn, confirm the successful creation of the user PCM account and secure storage of the encrypted PCM package 142′. In such an embodiment, the registration process may be deemed complete, and the user can proceed to authenticate using SDI-based authentication instead of relying on passwords, as described.

By implementing this method, the user may benefit from a cryptographic identity verification system that enhances security, prevents credential theft, and enables seamless authentication across multiple service providers.

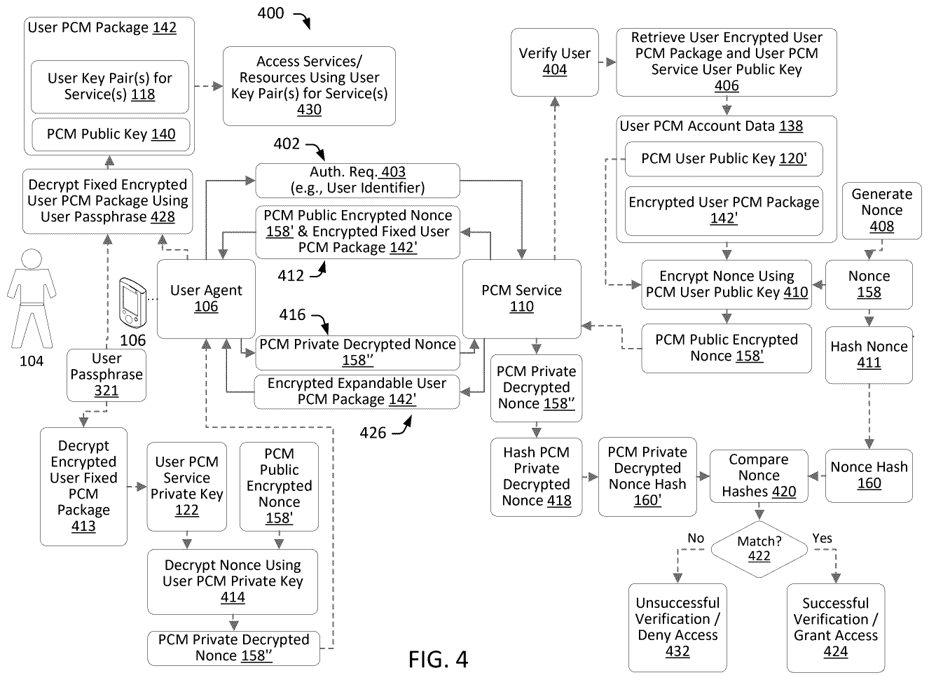

FIG. 4 is a flow diagram that illustrates a method 400 of service-based identity verification in accordance with one or more embodiments. Some or all of the procedural elements of method 400 may be performed, for example, by one or more entities of identity verification system 100 or another entity. For example, some or all of the operations of method 400 may be performed by the user agent 106, the PCM service 110, the SDI-enabled service provider 112, or the user 104. Embodiments of method 400 may facilitate authentication without exposing passwords by using cryptographic challenge-response mechanisms.

In the illustrated embodiment, at step 402, the user agent 106 (first entity) transmits a PCM service authentication request 403 to the PCM service 110 (second entity). The request may include a user identifier (e.g., a username), or other identifying information for identifying the source of the request. For example, when Mike Smith attempts to log into his banking service using his SDI-enabled identity verification application 114 on his mobile device 116, the application may send his username (mikesmith2024) to the PCM service 110.

At step 404, the PCM service 110 verifies the user identifier and, in response, at step 406, retrieves corresponding user PCM account data 138 that includes an encrypted PCM package 142′ and a user PCM public key 140 associated with the user's PCM account. For example, after verifying an account associated with the username “mikesmith2024” exists, the PCM service 110 retrieves Mike's user PCM account data 138, including his previously encrypted PCM package 142′ (e.g., including both the encrypted fixed and expandable package versions) and Mike's PCM user public key (PCM-PK-098A).

At step 408, the PCM service 110 generates a nonce (“PCM authentication nonce”) 158 for validation. For example, the PCM service 110 generates a unique nonce (N47HY89T) for this authentication session with Mike Smith. As described, such a nonce can ensure that the authentication request is unique, preventing replay attacks.

At step 410, the PCM service 110 encrypts the nonce 158 using the user's PCM public key 120′ to generate a PCM public encrypted nonce 158′. For example, the PCM service 110 encrypts the nonce (N47HY89T) using Mike's PCM user public key (ENC_RSA (N47HY89T, PCM-PK-098A)=e9f1d5c7a3b2 . . . ). The encrypted nonce can ensure that only the intended user, who possesses the corresponding private key, can decrypt and respond to the nonce challenge.

At step 411, the PCM service 110 hashes the nonce 158 to generate a hash of the original nonce, a nonce hash 160. This may also include storing the nonce hash 160 (e.g., in a memory of the PCM service 110 for later comparison) and discarding the plaintext original nonce 158. This may prevent unauthorized recovery of the nonce 158 while still allowing verification. The hashing process may be performed using a secure cryptographic hash function, such SHA-256, as follows: HASH_SHA 256 (N47HY89T)=6d3a5f9e8b47c2elf0a4 . . . , to generate the nonce hash 160 (e.g., 6d3a5f9e8b47c2elf0a4 . . . ).

At step 412, the PCM service 110 transmits the PCM public encrypted nonce 158′ and the encrypted fixed package version of the encrypted PCM package 142′ to the user agent 106. For example, the PCM service 110 sends the encrypted nonce (e9f1d5c7a3b2 . . . ) and the encrypted fixed version of the encrypted PCM package 142′ to Mike's app 114 for decryption.

At step 413, the user agent 106 obtains the user passphrase 321 and uses it to decrypt the encrypted fixed version of the PCM package 142′, to access the user PCM service private key 122′ stored therein. For example, the app 114 prompts Mike to enter his passphrase (BlueSky #2024) and decrypts the fixed version of the PCM package 142′ (PCM-FX PK G) using Mike's passphrase (DEC_AES256 (PCM-FXPKG, BlueSky #2024)) to access the PCM user service key pair (PCM-PK-098A)/PCM-PRIV-098A) 122′ in the read-only tree of the fixed version of the PCM package.

At step 414, the user agent 106 decrypts the PCM public encrypted nonce 158′ using the PCM user service private key 122′ to generate a PCM private decrypted nonce 158″. For example, Mike's app 114 decrypts the PCM/public encrypted nonce 158′ using his PCM private key (DEC_RSA (e9f1d5c7a3b2 . . . , PCM-PRIV-098A)=N47HY89T) 122′ to generate the PCM private decrypted nonce 158″ (N47HY89T).

At step 416, the user agent 106 transmits the PCM private decrypted nonce 158″ to the PCM service 110 as proof of identity. For example, Mike's app 114 transmits the PCM private decrypted nonce 158″ (N47HY89T) to the PCM service 110 for identity verification.

At step 418, the PCM service 110 hashes the received PCM decrypted nonce 158″ to generate a PCM private decrypted nonce hash 160′. For example, the PCM service applies SHA-256 hashing (HASH_SHA 256 (N47HY89T)=6d3a5f9e8b47c2elf0a4 . . . ) to generate PCM private decrypted nonce hash 160′ (6d3a5f9e8b47c2elf0a4 . . . ).

At step 420, the PCM service 110 compares the PCM private decrypted nonce hash 160′ with the originally stored PCM nonce hash 160 to verify identity.

At step 422, if the value of the PCM private decrypted nonce hash 160′ matches the value of the originally stored PCM nonce hash 160, the identity verification is deemed verified (or “successful”) at step 424, and access is granted to the resource-here the expandable version of the PCM package 142′. This may include sending the user's encrypted PCM package 142′ to the user agent 106, at step 426. For example, in response to verifying Mike's identity based on a match of the values of the PCM private decrypted nonce hash 160′ (6d3a5f9e8b47c2elf0a4 . . . ) and the nonce hash 160 (6d3a5f9e8b47c2elf0a4 . . . ), the PCM service 110 may, in turn, transmit the encrypted expandable version of Mike's PCM package 142′ to Mike's app 114.

At step 428, the user agent 106 may obtain the user passphrase and decrypt the encrypted expandable version of the PCM package 142′ using the passphrase, to access its one or more service provider key pairs 118 for service providers 112. For example, the app 114 of the user agent 106 may use Mike's previously provided passphrase (BlueSky #2024) to decrypt the expandable version of the PCM package 142′ (PCM-EX PPKG) (DEC_AES256 (PCM-EXPPKG, BlueSky #2024)) to access the key pairs for services 118 stored therein, including the banking service key pair: BANK-PK-789X/BANK-PRIV-789X, the shopping service key pair: SHOP-PK-456Y/SHOP-PRIV-456Y; and the PCM service key pair: PCM-PK-098A/PCM-PRIV-098A.

At step 430, the user agent 106 may utilize the service provider key pair 118 for a service provider 118 of the decrypted PCM package 142. For example, the app 114 may use the banking service key pair to verify Mike's identity with his bank. As another example, the app 114 may add, delete, or modify data in the PCM package 142, such as cryptographic key pairs for service providers 118, encrypt the updated PCM package and transmit the updated encrypted PCM package to the PCM service 110 for secure storage, as described.

At step 432, if the value of PCM private decrypted nonce hash 160′ does not match the value of the originally stored nonce hash 160, the identity verification is deemed not verified (or “unsuccessful”). For example, the PCM service 110 may deny Mike Smith and his user agent 106 access to the expandable version of the encrypted PCM package 142′ in response to an unsuccessful verification process.

By implementing this method, the authentication process eliminates reliance on shared secrets and passwords, reducing the risks of phishing attacks and credential theft while ensuring seamless access to multiple services using cryptographic identity verification.

FIGS. 5A and 5B are flow diagrams that illustrate method 500 (500a and 500b) of service-based identity verification with a service provider in accordance with one or more embodiments. Some or all of the procedural elements of method 500 may be performed, for example, by one or more entities of identity verification system 100 or another entity. For example, some or all of the operations of method 500 may be performed by the user agent 106, the PCM service 110, the SDI-enabled service provider 112, or the user 104. This process demonstrates a user securely expanding their Personal Cryptographic Matter (PCM) package and modifying it to include new service-specific cryptographic key pairs.

Referring to method 500a of FIG. 5A, at step 502, the user agent 106 (first entity) transmits a service registration request 503 to the SDI-enabled service provider 112 (third entity), with the request indicating that the user wishes to register a new account using their existing SDI framework. For example, Mike Smith wants to register his Secure Digital Identity (SDI) with an online Car rental service, and prompts his user agent 106, which, in turn, sends a registration request to the car rental service.

At step 504, the service provider 112 issues an activation code 156 that is received by the user agent 106. The activation code 156 is sent to the user 104 and serves as a verification mechanism. For example, the car rental service emails Mike an activation code “CAR-XY 789” to confirm his request, and the user agent 106 obtains the activation code from Mike, e.g., via a prompt.

At step 506, the user agent 106 transmits a service PCM registration request, to the PCM service 110 (second entity), requesting access to the expandable version of the user's encrypted PCM package 142″. For example, Mike's app 114 sends the username (mikesmith2024) to the PCM service 110, along with an indication of a desire to update his PCM package.

At step 510, the PCM service 110 verifies the login credentials and, in response, retrieves the user's existing encrypted PCM package 142′ containing previously registered cryptographic key pairs for other services (e.g., banking and shopping services), and sends the expandable version of the encrypted PCM package 142 to the user agent 106, at step 512. This may be accomplished in a similar manner as that described with regard to method 400 of FIG. 4, including use of the fixed version of the encrypted PCM package to verify identity by way of a nonce challenge, followed by sending the encrypted expandable version of the encrypted PCM package 142′.

At step 512, the user agent 106 generates a modified PCM package 142. This may include decrypting the expandable version of the encrypted PCM package 142′ using the user's passphrase 321 to decrypt and expand the PCM package 142′, generating a new cryptographic key pair 118″ (e.g., including a user public key 120′″ and a user private key 122″) specifically for the new SDI-enabled service provider 112, and modifying the expandable PCM package 142 to include the new cryptographic key pair 118′″. For example, upon receipt of the expandable version of the encrypted PCM package 142′, Mike's app 114 prompts him to enter his passphrase (BlueSky #2024). Using AES-256, the app 114 decrypts and expands the expandable PCM package (DEC_AES256 (PCM-EX PPKG, BlueSky #2024)), and integrates the new cryptographic key pair 118′″ for the car rental service (Car rental service Key Pair: CAR-PK-678Z/CAR-PRIV-678Z) into the expanded, modifiable listing of cryptographic key pairs 118 in the tree of the PCM package 142 (e.g., adding it alongside his Banking and Shopping key pairs). This may ensure that each service provider has a unique identity credential within the tree of the resulting PCM package 142.

At step 514, the user agent 106 encrypts the updated PCM package 142 using the user passphrase 513 to generate an encrypted PCM package 142′. For example, Mike's app 114 encrypts the updated PCM package 142 using AES-256 with his passphrase (ENC_AES256 (Updated PCM-Tree, BlueSky #2024)), to generate modified encrypted PCM package 142′, which may include an encrypted expandable version and an encrypted fixed version of Mike's modified PCM package 142.

At step 516, the user agent 106 transmits the modified encrypted PCM package 142′ to the PCM service 110 for secure storage. For example, Mike's app 114 sends modified encrypted PCM package 142′ to the PCM service 110 for storage.

At step 518, the PCM service 110 stores modified encrypted PCM package 142′. For example, the PCM service 110 stores and maintains the encrypted modified PCM package 142″ in his user PCM account data 138, which may include the encrypted expandable version and the encrypted fixed version of Mike's modified PCM package 142.

At step 520, the user agent 106 generates a user data bundle 522 that includes the newly generated public key 120′″ for the service 112, the activation code 156, and an anonymized user ID 523. This data bundle may allow the service provider 112 to associate the user's SDI identity and the user's public key for that service within their system. For example, Mike's app 114 prepares a user data bundle 522 for the car rental service that includes the car rental Public Key 120′″ (CAR-PK-678Z), the activation code (CAR-XY 789) previously provided, and an anonymized User ID, which may be a hash of Mike's e-mail and a security key (HASH_SHA 256 (mike.smith@ email.com+Secret Key)=D5E4A 9F 3B 7C2 . . . ).

At step 524, the user agent 106 transmits the user data bundle 522 to the SDI-enabled service provider 112 for verification and registration completion. For example, Mike's app 114 sends Mike's user data bundle 522 to the car rental service, allowing its system to finalize his SDI-based registration, including storing the car rental service user public key 120′″ (CAR-PK-678Z) for use in verifying future transactions with Mike, as described here, such as with regard to FIG. 5B.

By implementing this method, users can securely register with new SDI-enabled services while maintaining a cryptographically secure, decentralized authentication model. This process may eliminate reliance on shared secrets and passwords, ensuring privacy-preserving identity verification.

Referring to FIG. 5B, illustrated is a portion of method 500 for verifying a user's identity using an identity verification challenge-response process that involves a trusted PCM service associated with a service provider. This process may ensure that a user data bundle is valid.

Referring to method 500b of FIG. 5B, at step 528, the service provider 112 receives the user data bundle 522 from the user agent 106, which contains the newly generated service provider public key 120′, the activation code 156, and the anonymized user ID. For example, continuing with the prior example, the car rental service receives Mike Smith's user data bundle 522 (transmitted at step 524) that includes his newly generated car rental user public key (CAR-PK-678Z), the activation code (CAR-XY 789), and the anonymized hash of his email and secret key for use in identity verification.

At step 530, the service provider 112 validates the activation code 156 and the anonymized user ID received in the user data bundle 522. This step ensures that the request originates from a legitimate user. For example, the car rental service verifies that activation code (CAR-XY 789) is valid and has not been used previously and checks to confirm that the received anonymized user ID (D 5E4A 9F 3B 7C2 . . . ) does not correspond to an existing user record in its system to ensure the user does not already have an account or have information that conflicts with an existing user.

At step 532, the service provider 112 generates a nonce 158 (a unique cryptographic challenge) to confirm that the user agent 106 has control over PCM public key 140 of the associated PCM service 110. For example, the car rental service generates a random nonce (N89HY456T) as part of the verification process.

At step 534, the service provider 112 hashes the nonce 158 to generate a nonce hash 160. The nonce hash is stored, while the original nonce is discarded to enhance security. For example, the car rental service hashes the generated nonce: HASH_SHA 256 (N89HY456T)=A 1B 3C5D 7E9F2 . . . . This may also include storing the nonce hash 160 (e.g., in a memory of the car rental service for later comparison) and discarding the plaintext original nonce 158. This may prevent unauthorized recovery of the nonce 158 while still allowing verification.

At step 536, the service provider 112 transmits the unencrypted nonce 158 to the user agent 106 for use in authentication verification. For example, the car rental service sends the plaintext nonce (N89HY456T) to Mike's app 114.

At step 538, the user agent 106 retrieves the user PCM public key 140 from the user's PCM package 142 (e.g., previously requested, received and decrypted). For example, Mike's app 114 retrieves Mike's PCM public key (UPCM-PK-098A) from the decrypted PCM package 142.

At step 540, the user agent 106 encrypts the nonce 158 using the PCM public key 140 to generate a PCM public encrypted nonce 158′. For example, Mike's app encrypts the nonce: ENC_RSA (N89HY456T, UPCM-PK-098A)=F5D 9C2E3A 7B 6 . . .

At step 542, the user agent 106 transmits the PCM public encrypted nonce 158′ to the service provider 112, which forwards the PCM public encrypted nonce 158′ to the PCM service for verification, at step 546. For example, Mike's app 114 sends the encrypted nonce (F5D9C2E3A 7B 6 . . . ) to the car rental service, which forwards it to the PCM service 110.

At step 544, the PCM service 110 decrypts the service provider encrypted nonce 158′ using the corresponding user PCM private key 141 to generate a decrypted nonce 158″. For example, the PCM service decrypts the nonce: DEC_RSA (F5D9C2E3A 7B6 . . . , CAR-PRIV-678Z)=N89HY456T.

At step 546, the PCM service 110 transmits the decrypted nonce 158″ back to the service provider 112 for final verification. For example, the PCM service 110 sends the decrypted nonce (N89HY 456T) back to the car rental service.

At step 550, the service provider 112 hashes the received decrypted nonce 158″ to generate a decrypted nonce hash 160′. For example, the car rental service applies SHA-256 hashing (HASH_SHA256 (N89HY456T)=A1B3C5D7E9F2 . . . ) to generate decrypted nonce hash 160′ (A 1B 3C5D 7E9F2 . . . ).

At step 552, the service provider 112 compares the decrypted nonce hash 160′ with the originally stored PCM nonce hash 160 to verify authentication from step 534. If the hashes match, the user is authenticated successfully. Example: The Car rental service computes HASH_SHA 256 (N89HY 456T)=A 1B 3C5D 7E9F2 . . . and verifies that it matches the stored hash.

At step 554, if the value of the decrypted nonce hash 160′ matches the value of the originally stored PCM nonce hash 160, the identity verification is deemed verified (or “successful”) and registration in completed, at step 556, including associating the service provider public key 120′ with the user profile. For example, the car rental service links Mike's car rental user public key (CAR-PK-678Z) to his customer profile, enabling secure future logins. If the hashes do not match, authentication is deemed unsuccessful, and the service provider 112 denies the registration request, at step 558. For example, if the received hash does not match the stored hash, the car rental service rejects the registration attempt.

By implementing this method, SDI-enabled service providers can securely verify user identities without relying on traditional credentials. This may ensure that the user agent 106 has access to the correct cryptographic key, providing strong identity verification and privacy protection.

### Example of the Secure Digital Identity (SDI) Process

The following is an example of Mike Smith's Secure Digital Identity (SDI) journey, illustrating how he engages with an SDI-enabled service provider (First Secure Bank), registers with a PCM Service, logs into his SDI-enabled service provider, registers with another SDI-enabled service provider (SafeDrive car rentals), and logs into the new SDI-enabled service provider.

Step 1: Mike Engages with an SDI-Enabled Service Provider (First Secure Bank)

Mike wants to open an online banking account at First Secure Bank, an SDI-enabled service provider. Mike visits First Secure Bank's website and selects “Sign up with Secure Digital Identity (SDI).” First Secure Bank detects that Mike does not yet have an SDI and instructs him to register with a PCM Service. First Secure Bank issues an activation code (ACT-1A 34RFT) for Mike to use when registering with the PCM Service.

Step 2: Mike Registers with the PCM Service (PCM Creation & Initialization, e.g., see FIG. 3 & FIG. 5A)

Mike now needs to register with a PCM Service, which will securely store his cryptographic identity. Mike installs the PCM Service mobile app and selects “Register New PCM.” Mike enters the activation code (ACT-1A 34RFT), email (mike.smith@ email.com), and desired username (mikesmith2024). The PCM Service validates the activation code with First Secure Bank. Mike's mobile app generates a new user PCM Public-Private Key Pair: PCM User Public Key: PCM-PK-098A and PCM User Private Key: PCM-PRIV-098A, and stores it locally in his device's). A new PCM tree is created and initialized with key pairs for First Secure Bank: First Secure Bank User Key Pair: Public Key: BANK-PK-789X and Private Key: BANK-PRIV-789X (to be used for authentication). Mike is prompted to create a passphrase (BlueSky #2024) for securing his PCM package. His PCM package, including the tree, is encrypted using AES-256 with his passphrase. The encrypted PCM package is uploaded to the PCM Service. Mike mobile app sends Mike's First Secure Bank user public key (BANK-PK-789X) to First Secure Bank and sends Mike's PCM user public key (PCM-PK-098A) to the PCM Service.

Step 3: Mike Logs into First Secure Bank Using SDI (PCM Retrieval & Use, e.g., see FIG. 2 & FIG. 4)

Now that Mike's PCM is registered, he wants to log into First Secure Bank using SDI authentication. Mike visits First Secure Bank's login page and selects “Log in with Secure Digital Identity (SDI).” First Secure Bank requests authentication from Mike's mobile app via nonce challenge-including First Secure Bank encrypting a nonce using Mike's First Secure Bank public key (BANK-PK-789X) and sending the resulting public-encrypted nonce to Mike's mobile app for decryption. To retrieve Mike's First Secure Bank user private key (BANK-PRIV-789X), Mike's mobile app queries the PCM for his PCM package, which includes providing the PCM service with Mike's identifier (“mikesmith2024”). The PCM Service, then, executes a nonce challenge of its own before sending the PCM package-including encrypting a nonce using Mike's PCM public key (PCM-PK-098A) and providing the encrypted nonce and a fixed version of the encrypted PCM package associated with the identifier to Mike's mobile app, where Mike's mobile app decrypts the PCM package using Mik′e passphrase (BlueSky #2024) to access Mike's PCM private key (PCM-PRIV-098A), uses the PCM private key (PCM-PRIV-098A) to decrypt the encrypted nonce, and sends the decrypted nonce to the PCM Service. Upon verifying the decrypted nonce (e.g., via a comparison and match of a hash of the original nonce to a hash of the decrypted nonce), the PCM Service validates Mike's identity and sends the expandable version of Mike's encrypted PCM package to Mike's mobile app. Mike's mobile app decrypts the expandable version of the PCM package using his passphrase (BlueSky #2024) and retrieves the Banking U ser Key Pair: Public Key: BANK-PK-789X and Private Key: BANK-PRIV-789X from the tree of the decrypted PCM package. First Secure Bank generates a nonce (N47HY 89T), encrypts it using Mike's Banking user public key (BANK-PK-789X) that was previously provided by Mike's mobile app, and stores a hash of the nonce. Mike's mobile app decrypts the nonce using Mike's Banking user private key (BANK-PRIV-789X), which it retrieved from the PCM package, and sends it back to First Secure Bank. First Secure Bank hashes the received nonce and compares it with the stored hash. If the hashes match, authentication is successful, and Mike is logged into his bank account or otherwise provided access to a resource.

Step 4: Mike Registers with Another SDI-Enabled Service (SafeDrive car rentals, e.g., see FIG. 5A & FIG. 5B)

Mike wants to register with SafeDrive car rentals, another SDI-enabled service provider. Mike visits SafeDrive's website and selects “Register with Secure Digital Identity (SDI).” SafeDrive issues an activation code (CAR-XY 789). Mike opens his PCM Service app and selects “Add New Service.” Mike's app interacts with the PCM Service to retrieve and decrypt the expandable version of his PCM package as described previously. A new car rental user key pair is generated and added to the tree of the PCM package: Public Key: CAR-PK-678Z and Private Key:

CAR-PRIV-678Z. The updated PCM package, including the updated tree, is encrypted and sent back to the PCM Service for storage. Mike's app creates a user data bundle, including the car rental public key (CAR-PK-678Z), the activation code (CAR-XY 789), and an anonymized identifier (e.g., a hash of Mike's e-mail and a secret key) and sends it to SafeDrive for verification. SafeDrive verifies the activation code and matches the anonymized user ID. In a subsequent PCM service authentication step, SafeDrive issues a nonce, which Mike's app encrypts using Mike's user PCM public key (UPCM-PK-098A). Mike's app sends the encrypted nonce to SafeDrive car rentals, which forwards it to the PCM Service, which, in turn, decrypts the nonce using Mike's account's user PCM private key (UPCM-PRIV-098A) and returns it to SafeDrive car rentals for verification. SafeDrive car rentals hashes the nonce and compares it with the stored hash. If the hashes match, authentication is successful, and SafeDrive car rentals completes registration and links Mike's public key (CAR-PK-678Z) to Mike's account for use in future verifications.

Step 5: Mike Logs into SafeDrive car rentals Using SDI Authentication (FIG. 4 & FIG. 5B)

Now that Mike is registered, he wants to log into SafeDrive car rentals using SDI authentication. Mike's app queries SafeDrive car rentals, and SafeDrive car rentals encrypts a nonce with Mike's user public key (CAR-PK-678Z), sends the encrypted nonce to Mike's app, and stores a hash of the nonce. Mike's app retrieves his SafeDrive car rentals user private key (CAR-PRIV-678Z) (e.g., from the PCM Service as previously described), and uses it to decrypt the nonce. Mike's app sends the decrypted nonce back to SafeDrive car rentals for verification. SafeDrive car rentals hashes the nonce and compares it with the stored hash. If the hashes match, authentication is successful, and SafeDrive car rentals provides Mike's app with access to a resource, such as booking a car rental.

This example demonstrates how Mike Smith seamlessly interacts with multiple SDI-enabled service providers using a cryptographic identity verification system. By eliminating reliance on traditional passwords and instead leveraging public-private key authentication, nonce-based challenges, and secure PCM storage, Mike experiences enhanced security, reduced risk of credential theft, and a seamless user experience across various service providers.

FIG. 6 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random-access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to one or more of the entities described (e.g., PCM service 110, user agent 106, or service provider 112), or one or more of the operations described (e.g., operations of methods 200, 300, 400, or 500).

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each includes a group of one or more processors that are used for executing the processing described here. The I/O interface 1008 may provide an interface for communication with one or more I/O devices 1014, such as a joystick, a computer mouse, a keyboard, or a display/touch screen (e.g., an electronic display for displaying a graphical user interface (GUI)). The I/O devices 1014 may include one or more of the user-input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers, or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here; parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

The following enumerated embodiments further demonstrate the techniques described:
1. A method for cryptographically verifying identity, the method comprising:
   obtaining, by a first entity, a cryptographic private key associated with a user; obtaining, by a second entity, a cryptographic public key corresponding to the cryptographic private key;
   generating, by the second entity, a nonce for authentication;
   encrypting, by the second entity, the nonce using the cryptographic public key to generate an encrypted nonce;
   hashing, by the second entity, the nonce to generate a nonce hash;
   transmitting, from the second entity to the first entity, the encrypted nonce;
   decrypting, by the first entity, the encrypted nonce using the cryptographic private key to generate a decrypted nonce;
   transmitting, from the first entity to the second entity, the decrypted nonce;
   hashing, by the second entity, the decrypted nonce to generate a decrypted nonce hash;
   determining, by the second entity, that the decrypted nonce hash matches the nonce hash; and
   verifying, based on the determination that the decrypted nonce hash matches the nonce hash, a digital identity of the user.
2. The method of embodiment 1, further comprising:
   storing, by the second entity, the nonce hash in a memory for comparison with the decrypted nonce hash; and
   removing, by the second entity, the nonce from memory.
3. The method of embodiment 1 or 2, further comprising:
   providing, responsive to verifying the digital identity of the user, the user with access to a resource associated with the second entity.
4. The method of any one of embodiments 1-3, further comprising:
   determining, by the second entity, that a second decrypted nonce hash does not match a second nonce hash; and
   not verifying, based on the determination that the second decrypted nonce hash does not match the second nonce hash, the digital identity of a second user.
5. The method of any one of embodiments 1-4, wherein the first entity comprises a user agent executing on a computing device and the second entity comprises a service provider server.
6. The method of any one of embodiments 1-5, wherein the nonce comprises a random byte array generated for a single authentication session.
7. The method of any one of embodiments 1-6, wherein the public and private cryptographic keys are generated by the user agent, wherein the public and private cryptographic keys are stored in a personal cryptographic matter (PCM) associated with the user, and wherein the PCM associated with the user is stored in a remote location by a third entity.
8. A system comprising:
   a processor; and
   non-transitory computer readable storage medium comprising program instructions stored thereon that are executable by a processor to perform the method of any one of embodiments 1-7.
9. A non-transitory computer readable storage medium comprising program instructions stored thereon that are executable by a processor to perform the method of any one of embodiments 1-7.
10. A method for cryptographic identity verification, the method comprising:
   generating, by the user agent, a cryptographic key pair associated with the user, the cryptographic key pair comprising a cryptographic public key and a cryptographic private key;
   transmitting, from the user agent to a personal cryptographic matter (PCM) service, the cryptographic public key and the registration data;
   the PCM service, storing the cryptographic public key and the registration data in association with a PCM account for the user;
   receiving, by the user agent, an encryption passphrase from the user;
   generating, by the user agent, a PCM package comprising a cryptographic key pair associated with a service provider;
   encrypting, by the user agent, the PCM package using the encryption passphrase to generate an encrypted PCM package; and
   transmitting, from the user agent to the PCM service, the encrypted PCM package;
   the PCM service storing the encrypted PCM package in association with the PCM account for the user.
11. The method of embodiment 10, wherein the PCM package comprises multiple cryptographic key pairs associated with different service providers.
12. The method of embodiment 10 or 11, further comprising:
   requesting, by the user agent, the encrypted PCM package from the PCM service;
   receiving, by the user agent, the encrypted PCM package from the PCM service;
   decrypting, by the user agent, the PCM package received using the encryption passphrase to generate a decrypted PCM package;
   generating, by the user agent, based on the PCM package an updated PCM package;
   encrypting, by the user agent, the updated PCM package using an encryption passphrase provided by the user to generate an updated encrypted PCM package;
   transmitting, from the user agent to the PCM service, the updated encrypted PCM package; and
   storing, by the PCM service, the updated encrypted PCM package in association with the PCM account for the user.
13. The method of embodiment 12, wherein generating an updated PCM package comprises adding a cryptographic key pair to the PCM package, deleting a cryptographic key pair from the PCM package, or modifying a cryptographic key pair of the PCM package.
14. The method of any one of embodiments 10-13, wherein the encrypted PCM package is stored in an expandable format for user updates and a fixed format for authentication purposes.
15. The method of any one of embodiments 10-14, wherein the registration data comprises an activation code provided by a service provider, and the method further comprising:
   verifying, by the PCM service, the activation code,
   wherein the storing, by the PCM service, of the cryptographic public key and the registration data in association with the PCM account for the user is performed responsive to verifying the activation code.
16. The method of any one of embodiments 10-15, further comprising:
   generating, by the PCM service, a user PCM cryptographic key pair comprising a user PCM cryptographic public key and a user PCM cryptographic private key; and
   providing, by the PCM service, the user PCM cryptographic public key to the user agent,
   wherein the PCM package generated by the user agent comprises the user PCM cryptographic public key such that the encrypted PCM package comprises the PCM cryptographic public key.
17. A system comprising:
   a processor; and
   non-transitory computer readable storage medium comprising program instructions stored thereon that are executable by a processor to perform the method of any one of embodiments 10-16.
18. A non-transitory computer readable storage medium comprising program instructions stored thereon that are executable by a processor to perform the method of any one of embodiments 10-16.
19. A method for employing authentication credentials using cryptographic identity verification, the method comprising:
   receiving, by a personal cryptographic matter (PCM) service, a user authentication request from a user agent associated with a user having a user account;
   retrieving, by the PCM service, an encrypted PCM package associated with the user account, the PCM package comprising authentication credentials for one or more service providers;
   generating, by the PCM service, a nonce for identity verification;
   hashing, by the PCM service, the nonce to generate a nonce hash;
   encrypting, by the PCM service, the nonce using a cryptographic public key associated with the user account to generate an encrypted nonce;
   transmitting, by the PCM service, the encrypted nonce to the user agent;
   decrypting, by the user agent, the encrypted nonce using a cryptographic private key associated with the user;
   transmitting, from the user agent to the PCM service, the decrypted nonce for verification;
   hashing, by the PCM service, the decrypted nonce to generate a hashed decrypted nonce;
   determining, by the PCM service, that the hashed decrypted nonce matches the nonce hash;
   transmitting, by the PCM service responsive to determining that the hashed decrypted nonce matches the nonce hash, the encrypted PCM package to the user agent; and
   decrypting, by the user agent, the encrypted PCM package using an encryption passphrase to extract the authentication credentials from the encrypted PCM package.
20. The method of embodiment 19, further comprising the PCM service transmitting, to the user agent, an encrypted fixed PCM package comprising the cryptographic private key associated with the user, wherein the user agent decrypts the encrypted fixed PCM package to extract the cryptographic private key associated with the user, and wherein the encrypted PCM package comprises an encrypted expandable PCM package.
21. The method of embodiment 19 or 20, further comprising:
   storing, by the PCM service, the nonce hash in a memory for comparison with the hashed decrypted nonce; and
   discarding, by the PCM service, the nonce.
22. The method of any one of embodiments 19-21, further comprising:
   employing, by the user agent, an authentication credential extracted from the decrypted PCM package to obtain a resource from a service provider.
23. The method of any one of embodiments 19-22, further comprising:
   generating, by the user agent, a service provider cryptographic key pair associated with a service provider, wherein the authentication credentials comprise the service provider cryptographic key pair;
   employing, by the user agent, the service provider key pair to authenticate with the service provider.
24. The method of any one of embodiments 19-23, further comprising:
   generating, by the user agent, a user cryptographic key pair comprising the cryptographic public key associated with the user account and the cryptographic private key; and
   transmitting, by the user agent, the cryptographic public key to the PCM service, the PCM service being configured to use the cryptographic public key to authenticate the user agent.
25. The method of any one of embodiments 19-24, wherein the user agent comprises an application executing on a first computing device and the PCM service comprises a second computing device remote from the first computing device.
26. The method of any one of embodiments 19-25, wherein the user authentication request comprises a user identifier associated with the user account, the method further comprising:
   verifying, by the PCM service, that the user identifier is associated with a user account,
   wherein the PCM service retrieves the encrypted PCM package associated with the user account in response to verifying that the user identifier is associated with the user account.
27. A system comprising:
   a processor; and
   non-transitory computer readable storage medium comprising program instructions stored thereon that are executable by a processor to perform the method of any one of embodiments 19-26.
28. A non-transitory computer readable storage medium comprising program instructions stored thereon that are executable by a processor to perform the method of any one of embodiments 19-26.
29. A method for secure digital identity (SDI) verification, comprising:
   receiving, by a user agent, an activation code associated with a service provider;
   generating, by the user agent, a cryptographic key pair associated with the service provider,
      the cryptographic key pair associated with the service provider comprising:
         a service provider user cryptographic public key; and
         a service provider user cryptographic private key;
   generating, by the user agent, personal cryptographic matter (PCM) package comprising the cryptographic key pair associated with the service provider;
   obtaining, by the user agent, an encryption passphrase;
   encrypting, by the user agent, the PCM package using the encryption passphrase to generate an encrypted PCM package;
   transmitting, from the user agent to the PCM service, the encrypted PCM package, the PCM service storing the encrypted PCM package;
   generating, by the user agent, a user data bundle comprising:
      the service provider user cryptographic public key;
      the activation code associated with the service provider; and
      a user identifier;
   transmitting, from the user agent to the service provider, the user data bundle;
   employing, by the user agent, the service provider user cryptographic private key to verify identity with the service provider.
30. The method of embodiment 29, wherein the anonymized user identifier comprises a cryptographic hash of a user identifier and a secret key.
31. The method of embodiment 29 or 30, wherein employing the service provider user cryptographic private key to validate identity with the service provider comprises:
   generating, by the service provider, a nonce for authentication;
   encrypting, by the service provider, the nonce using the service provider user cryptographic public key to generate an encrypted nonce;
   hashing, by the service provider, the nonce to generate a nonce hash;
   transmitting, from the service provider to the user agent, the encrypted nonce;
   decrypting, by the user agent, the encrypted nonce using the service provider user cryptographic private key to generate a decrypted nonce;
   transmitting, from the user agent to the service provider, the decrypted nonce;
   hashing, by the service provider, the decrypted nonce to generate a hashed decrypted nonce;
   determining, by the service provider, that the hashed decrypted nonce matches the nonce hash; and
   verifying, by the service provider in response to the determination that the hashed decrypted nonce matches the nonce hash, a digital identity of the user agent.
32. The method of method of any one of embodiments 29-31, further comprising:
   receiving, by the user agent, a first encrypted PCM package from the PCM service; and
   decrypting, by the user agent, the first encrypted PCM package using a first passphrase provided by the user to generate a first decrypted PCM package,
   wherein the PCM package is generated based on the first decrypted PCM package.
33. The method of embodiment 32, further comprising providing, by the service provider, the user agent with access to a resource based on verifying the digital identity of the user.
34. The method of embodiment 33, wherein the resource comprises an electronic document.
35. The method of method of any one of embodiments 29-34, wherein the user agent comprises an application executing on a user computing device, the PCM service comprises a PCM service application executing on a PCM service server, and the service provider comprises a service provider application executing on a service provider server.
36. A system comprising:
   a processor; and
   non-transitory computer readable storage medium comprising program instructions stored thereon that are executable by a processor to perform the method of any one of embodiments 29-35.
37. A non-transitory computer readable storage medium comprising program instructions stored thereon that are executable by a processor to perform the method of any one of embodiments 29-35.
38. A method for secure digital identity (SDI) verification, comprising:
   obtaining, by a user agent, an encrypted personal cryptographic matter (PCM) package comprising a user PCM cryptographic public key corresponding to a user PCM cryptographic private key of PCM service;
   decrypting, by the user agent, the encrypted PCM package using a passphrase to generate a decrypted PCM package that comprises the user PCM cryptographic public key;
   generating, by the service provider, a nonce for authentication;
   hashing, by the service provider, the nonce to generate a nonce hash;
   transmitting, from the service provider to the user agent, the nonce;
   encrypting, by the user agent, the nonce using the user PCM cryptographic public key to generate an encrypted nonce;
   obtaining, by the PCM service, the encrypted nonce;
   decrypting, by the PCM service, the encrypted nonce using the user PCM cryptographic private key to generate a decrypted nonce;
   transmitting, from the PCM service to the service provider, the decrypted nonce;
   hashing, by the service provider, the decrypted nonce to generate a hashed decrypted nonce;
   determining, by the service provider, that the hashed decrypted nonce matches the nonce hash; and
   verifying, by the service provider based on the determination that the hashed decrypted nonce matches the nonce hash, a digital identity of the user.
39. The method of embodiment 38, further comprising:
   generating, by the user agent, a cryptographic key pair associated with the service provider, the cryptographic key pair associated with the service provider comprising:
      a service provider user cryptographic public key; and
      a service provider user cryptographic private key;
   transmitting, from the user agent to the service provider, the service provider user cryptographic public key;
   associating, by the service provider, the service provider user cryptographic public key with a profile based on the verification of the digital identity of the user.
40. The method of embodiment 39, further comprising:
   generating, by the service provider, a second nonce for authentication;
   encrypting, by the service provider, the second nonce using the service provider user cryptographic public key to generate a second encrypted nonce;
   hashing, by the service provider, the second nonce to generate a second nonce hash;
   transmitting, from the service provider to the user agent, the second encrypted nonce;
   decrypting, by the user agent, the second encrypted nonce using the service provider user cryptographic private key to generate a second decrypted nonce;
   transmitting, from the user agent to the service provider, the second decrypted nonce;
   hashing, by the service provider, the second decrypted nonce to generate a second hashed decrypted nonce;
   determining, by the service provider, that the second hashed decrypted nonce matches the second nonce hash; and
   verifying, based on the determination that the second hashed decrypted nonce matches the second nonce hash, a digital identity of the user.
41. The method of embodiment 40, further comprising providing, by the service provider, the user agent with access to a resource based on the verification of the digital identity of the user.
42. The method of embodiment 41, wherein the resource comprises an electronic document.
43. The method of embodiment 41, wherein the resource comprises a physical item.
44. The method of embodiment 38, wherein the user agent comprises an application executing on a user computing device, the PCM service comprises a PCM service application executing on a PCM service server, and the service provider comprises a service provider application executing on a service provider server.
45. A system comprising:
   a processor; and
   non-transitory computer readable storage medium comprising program instructions stored thereon that are executable by a processor to perform the method of any one of embodiments 38-44.
46. A non-transitory computer readable storage medium comprising program instructions stored thereon that are executable by a processor to perform the method of any one of embodiments 38-44.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). As used throughout this application, the term “to” does not limit the associated operation to being directly to. Thus, for example, transmitting an item “to” an entity may include transmitting an item directly to the entity or indirectly to the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method for cryptographically verifying identity, the method comprising:
obtaining, by a first entity, a cryptographic private key associated with a user;
obtaining, by a second entity, a cryptographic public key corresponding to the cryptographic private key;
generating, by the second entity, a nonce for authentication;
encrypting, by the second entity, the nonce using the cryptographic public key to generate an encrypted nonce;
hashing, by the second entity, the nonce to generate a nonce hash;
transmitting, from the second entity to the first entity, the encrypted nonce;
decrypting, by the first entity, the encrypted nonce using the cryptographic private key to generate a decrypted nonce;
transmitting, from the first entity to the second entity, the decrypted nonce;
hashing, by the second entity, the decrypted nonce to generate a decrypted nonce hash;
determining, by the second entity, that the decrypted nonce hash matches the nonce hash; and
verifying, based on the determination that the decrypted nonce hash matches the nonce hash, a digital identity of the user.

1. The method of claim 1, further comprising:
storing, by the second entity, the nonce hash in a memory for comparison with the decrypted nonce hash; and
removing, by the second entity, the nonce from memory.

2. The method of claim 1, further comprising:
providing, responsive to verifying the digital identity of the user, the user with access to a resource associated with the second entity.

3. The method of claim 1, further comprising:
determining, by the second entity, that a second decrypted nonce hash does not match a second nonce hash; and
not verifying, based on the determination that the second decrypted nonce hash does not match the second nonce hash, the digital identity of a second user.

4. The method of claim 1, wherein the first entity comprises a user agent executing on a computing device and the second entity comprises a service provider server.

5. The method of claim 1, wherein the nonce comprises a random byte array generated for a single authentication session.

6. The method of claim 1, wherein the public and private cryptographic keys are generated by the user agent, wherein the public and private cryptographic keys are stored in a personal cryptographic matter (PCM) associated with the user, and wherein the PCM associated with the user is stored in a remote location by a third entity.

7. A system comprising:
a processor; and
non-transitory computer readable storage medium comprising program instructions stored thereon that are executable by a processor to perform the following operations for cryptographically verifying identity:
obtaining, by a first entity, a cryptographic private key associated with a user;
obtaining, by a second entity, a cryptographic public key corresponding to the cryptographic private key;
generating, by the second entity, a nonce for authentication;
encrypting, by the second entity, the nonce using the cryptographic public key to generate an encrypted nonce;
hashing, by the second entity, the nonce to generate a nonce hash;
transmitting, from the second entity to the first entity, the encrypted nonce;
decrypting, by the first entity, the encrypted nonce using the cryptographic private key to generate a decrypted nonce;
transmitting, from the first entity to the second entity, the decrypted nonce;
hashing, by the second entity, the decrypted nonce to generate a decrypted nonce hash;
determining, by the second entity, that the decrypted nonce hash matches the nonce hash; and
verifying, based on the determination that the decrypted nonce hash matches the nonce hash, a digital identity of the user.

8. The system of claim 8, the operations further comprising:
storing, by the second entity, the nonce hash in a memory for comparison with the decrypted nonce hash; and
removing, by the second entity, the nonce from memory.

9. The system of claim 8, the operations further comprising:
providing, responsive to verifying the digital identity of the user, the user with access to a resource associated with the second entity.

10. The system of claim 8, the operations further comprising:
determining, by the second entity, that a second decrypted nonce hash does not match a second nonce hash; and
not verifying, based on the determination that the second decrypted nonce hash does not match the second nonce hash, the digital identity of a second user.

11. The system of claim 8, wherein the first entity comprises a user agent executing on a computing device and the second entity comprises a service provider server.

12. The system of claim 8, wherein the nonce comprises a random byte array generated for a single authentication session.

13. The system of claim 8, wherein the public and private cryptographic keys are generated by the user agent, wherein the public and private cryptographic keys are stored in a personal cryptographic matter (PCM) associated with the user, and wherein the PCM associated with the user is stored in a remote location by a third entity.

14. A non-transitory computer readable storage medium comprising program instructions stored thereon that are executable by a processor to perform the following operations for cryptographically verifying identity:
obtaining, by a first entity, a cryptographic private key associated with a user;
obtaining, by a second entity, a cryptographic public key corresponding to the cryptographic private key;
generating, by the second entity, a nonce for authentication;
encrypting, by the second entity, the nonce using the cryptographic public key to generate an encrypted nonce;
hashing, by the second entity, the nonce to generate a nonce hash;
transmitting, from the second entity to the first entity, the encrypted nonce;
decrypting, by the first entity, the encrypted nonce using the cryptographic private key to generate a decrypted nonce;
transmitting, from the first entity to the second entity, the decrypted nonce;
hashing, by the second entity, the decrypted nonce to generate a decrypted nonce hash;
determining, by the second entity, that the decrypted nonce hash matches the nonce hash; and
verifying, based on the determination that the decrypted nonce hash matches the nonce hash, a digital identity of the user.

15. The medium of claim 15, the operations further comprising:
storing, by the second entity, the nonce hash in a memory for comparison with the decrypted nonce hash; and
removing, by the second entity, the nonce from memory.

16. The medium of claim 15, the operations further comprising:
providing, responsive to verifying the digital identity of the user, the user with access to a resource associated with the second entity.

17. The medium of claim 15, the operations further comprising:
determining, by the second entity, that a second decrypted nonce hash does not match a second nonce hash; and
not verifying, based on the determination that the second decrypted nonce hash does not match the second nonce hash, the digital identity of a second user.

18. The medium of claim 15, wherein the first entity comprises a user agent executing on a computing device and the second entity comprises a service provider server.

19. The medium of claim 15, wherein the nonce comprises a random byte array generated for a single authentication session.

20. The medium of claim 15, wherein the public and private cryptographic keys are generated by the user agent, wherein the public and private cryptographic keys are stored in a personal cryptographic matter (PCM) associated with the user, and wherein the PCM associated with the user is stored in a remote location by a third entity.
